(19) United States
(12) Patent Application Publication
(10) Pub. No.: US 2025/0360703 A1
(43) Pub. Date: Nov. 27, 2025

(54) Process for Manufacturing Acoustical Panel

(71) Applicant: USG INTERIORS, LLC, Chicago, IL (US)

(72) Inventors: Qing Yu, Libertyville, IL (US); Timothy J. Miller, Mundelein, IL (US); Adam Warren Keller, Grayslake, IL (US); William Allen Frank, Lake Villa, IL (US); Patrick C. Burggraff, Cloquet, MN (US); Christopher Joseph Rokke, Saginaw, MN (US)

(21) Appl. No.: 18/670,621

(22) Filed: May 21, 2024

(51) Int. Cl. B32B 37/15; B32B 5/02; B32B 19/06; B32B 37/06; B32B 37/24; C03C 25/30; C03C 25/321

(52) U.S. Cl. CPC B32B 37/15; B32B 5/028; B32B 19/06; B32B 37/06; B32B 37/24; C03C 25/30; C03C 25/321; B32B 2037/243; B32B 2262/101; B32B 2262/108; B32B 2262/16; B32B 2305/026; B32B 2305/18; B32B 2307/102; B32B 2307/72; B32B 2307/7376; B32B 2309/02; B32B 2309/12; B32B 2315/08; B32B 2315/14; B32B 2607/00

(57) ABSTRACT

A process for manufacturing an acoustical panel comprises mixing an aqueous slurry comprising water and at least about 90 wt. % of mineral wool, glass wool, or a combination of mineral wool and glass wool, the mineral wool, the glass wool, or the combination of mineral wool and glass wool having an average diameter of at least about 5 microns on a dry basis, to produce an acoustical panel having a NRC of about 0.80 to about 1.00 and a CAC of about 30 to about 50.

### FIELD

The invention relates generally to a process for manufacturing an acoustical panel, particularly to a process for manufacturing an acoustical panel from an aqueous slurry comprising water and at least about 90 wt. % of mineral wool, glass wool, or a combination of mineral wool and glass wool, the mineral wool, the glass wool, or the combination of mineral wool and glass wool having an average diameter of at least 5 about microns, by through drying.

### BACKGROUND

Fibrous panels, such as ceiling tiles or acoustical panels, are generally laminated structures comprising a basemat and a non-woven glass or glass blended porous scrim. The acoustical performance of fibrous panels is a particularly important factor in use. Fibrous panels are designed to absorb sound/noise, as reflected by a NRC (noise reduction coefficient) rating, as well as to block sound from entering into adjacent plenum space, as reflected by a high CAC (ceiling attenuation class) rating.

It is particularly challenging to achieve both a high NRC and a high CAC rating at the same time in a single product. For example, many fibrous panels having relatively high NRC values (greater than 0.80), such as those made from low density fiberglass or stone wool basemats, tend to have CAC values lower than 30. On the other hand, acoustical panels having CAC values of 30 or higher are typically higher density products with NRC values of less than 0.80.

To produce fibrous panels with both high NRC and CAC values, a dual-layer approach is often used in which a front panel is adhered, typically through glue, to a back panel. The front panel provides most of the sound absorption performance (corresponding to NRC performance), and the back panel provides most of the sound blocking performance (corresponding to CAC performance). The resulting ceiling tiles have several drawbacks: (1) such dual-layer fibrous panels are usually very thick (about 1.5 inches to about 2 inches, or 3.80 cm to 5.10 cm) and heavy (greater than about 1.5 lbs per square foot or 7.3 kilograms per square meter), making installation difficult and slow; (2) dual-layer fibrous panels are harder to cut during in-field installation due to overall higher thickness and cuttability variability between the layers; (3) the front and back panels of such dual-layer fibrous panels are typically adhered manually with higher likelihood of quality issues such as edge damage, poor fit to grid, etc.; and (4) dual-layer ceiling tiles are much more expensive to produce and have a larger carbon footprint.

While NRC values can be increased by increasing the thickness of the fibrous panels, additional costs and/or production complications accompany such design choices as described in further detail below. For example, basemats are typically commercially produced by water-felting of dilute aqueous dispersions of mineral wool and lightweight aggregate. In the water-felting process, an aqueous slurry is flowed onto a moving foraminous support wire, such as that of a Fourdinier or Oliver mat forming machine, for dewatering. The slurry is first dewatered by gravity and then dewatered by vacuum suction means to form a wet basemat. The wet basemat is then further dewatered by pressing (with or without the application of additional vacuum) to the desired thickness between rolls and a support wire to remove additional water. The wet basemat is then typically dried in a heated convection drying oven or kiln. The dried material is cut to the desired dimensions to produce a basemat, which optionally may be fissured and/or perforated to impart acoustical absorbency, laminated with a scrim, and/or face coated, such as with paint, to produce ceiling tiles and acoustical panels. Notably, drying in the heated convection drying oven is the production limiting step, as well as being the most costly and energy-intensive production step. Higher caliper fibrous panels therefore require additional energy and time for production and have a larger carbon footprint.

US-2023-0035178-A1 teaches that wet basemats using relatively lower amounts of mineral wool are easier and less costly to dry. Moreover, relatively higher-caliper basemats, especially single-layer basemats having thickness greater than 1.0 inches are notoriously difficult to dry due to heat transfer limitations. Further increasing the drying air temperature is generally not acceptable as it leads to unacceptable amounts of darkening or even burning of the basemat surface.

### SUMMARY

A process for manufacturing an acoustical panel comprising mixing an aqueous slurry comprising water and at least about 90 wt. % of mineral wool, glass wool, or a combination of mineral wool and glass wool, the mineral wool, the glass wool, or the combination of mineral wool and glass wool having an average diameter of at least about 5 microns, and about 1 wt. % to about 10 wt. % of a binder, on a dry basis. Continuously flowing the aqueous slurry onto a moving foraminous support wire to form a wet basemat and dewatering the wet basemat, the dewatering step including pressing the wet basemat to a thickness of about 1.1 inches to about 2.0 inches or about 1.15 inches to about 1.55 inches. Pulling hot air through the wet basemat via vacuum through drying to form a dried basemat. Laminating a porous scrim to a facing side of the dried basemat. The acoustical panel has a density between about 7 pounds per cubic foot (lbs/ft³) to about 12 lbs/ft³, or between about 10 lbs/ft³ to about 12 lbs/ft³. The acoustical panel has a thickness of greater than about 1.1 inches, typically about 1.1 inches to about 1.5 inches. The acoustical panel has a noise reduction coefficient (NRC) of about 0.80 to about 1.00 and a ceiling attenuation class (CAC) of about 30 to about 50.

Further aspects and advantages will be apparent to those of ordinary skill in the art from a review of the following detailed description. While the methods and compositions are susceptible of embodiments in various forms, the description hereafter includes specific embodiments with the understanding that the disclosure is illustrative, and is not intended to limit the disclosure to the specific embodiments described herein.

### DETAILED DESCRIPTION

The invention relates generally to a process for manufacturing single-layer, high caliper basemats for fibrous panels. More specifically, the invention relates to a process for manufacturing single-layer, high caliper basemat for fibrous panels that is provided as a single layer and comprises at least about 90 weight percent mineral wool, based on the weight of the basemat. Surprisingly and unexpectedly, the composition of the basemat disclosed herein allows the production of acoustical panels having a noise reduction coefficient (NRC) value of at least about 0.80 in combination with a ceiling attenuation class (CAC) rating of at least about 30, while also having significantly decreased density (relative to conventional high NRC and high CAC dual-layer basemats described above). The combination of such properties is advantageous and unexpected, particularly when achieved without perforating or fissuring the basemats. Of course, the disclosed basemats may also be optionally perforated or fissured, if desired, but such modification is not needed to achieve the combination of a NRC value of at least about 0.80 in combination with CAC rating of at least about 30, and significantly decreased weight (relative to conventional high NRC and high CAC dual-layer basemats).

Moreover, because of the basemat composition as well as because the disclosed basemat is provided as a single layer having a thickness of greater than about 1.1 inches (2.80 cm) and up to about 1.5 inches (3.81 cm), the basemat can surprisingly be combined with a relatively thick back coating on a backing surface of the basemat, which enhances the CAC rating without significantly reducing the NRC rating, thereby advantageously allowing a NRC value of at least about 0.80 in combination with a ceiling attenuation class (CAC) rating of at least about 30.

Further still, and without intending to be bound by theory, the amount and selection of the mineral wool and glass wool used in the disclosed basemats has been found to advantageously promote the formation of a basemat that increases sound absorption, especially when the dried basemat is prepared by a through drying process comprising pulling hot air through the basemat via vacuum. Advantageously, when through drying is carried out to prepare the dried basemats disclosed herein, significantly less time is required during drying of the basemats with significant additional potential energy savings capable of being realized as well.

As used herein, the term “about” means +/−10% of any recited value, or in an alternative embodiment, +/−5% of any recited value. As used herein, this term modifies any recited value, range of values, or endpoints of one or more ranges.

As used herein, “substantially free” means that the basemat compositions and thus the final basemats according to the invention contain insignificant amounts of the specifically listed component(s). For example, the basemat compositions according to the disclosure may contain less than about 0.50 weight percent (wt. %), less than about 0.25 wt. %, or less than about 0.10 wt. % of clay, calcium carbonate, magnesium carbonate, vermiculite, glass beads, perlite, and/or a cellulose, based on the entire weight of the composition.

As used herein, the term “low density” refers to a basemat having a density of less than about 12 pounds (lbs) per cubic foot (ft³). For example, the disclosed basemat can have a density of less than about 11, less than about 10, or less than about 9 lbs/ft³. In embodiments, the disclosed basemat has a density between about 7 lbs/ft³ and about 12 lbs/ft³, or between about 10 lbs/ft³ and about 12 lbs/ft³. Such low density basemats provided as a single layer having a thickness of greater than about 1.1 inches (2.80 cm) and up to about 1.5 inches (3.81 cm) advantageously allow production of relatively low weight fibrous panels having weights of less than about 1.75 pounds per sf (lbs/sf), less than about 1.5 pounds per sf (lbs/sf), less than about 1.40 pounds per sf (lbs/sf), or less than about 1.25 pounds per sf (lbs/sf), which is particularly advantageous for installation.

As used herein, the term “fibrous panel” includes both “ceiling tiles” and “acoustical panels.” Further, as used herein, the terms “panel” and “tile” should be considered interchangeable.

As used herein, the term “high acoustic” refers to a basemat, optionally finished as a fibrous panel, having a relatively high noise reduction coefficient value greater than about 0.85 and a relatively high ceiling attenuation class rating greater than about 30. Sound absorption is typically measured by its Noise Reduction Coefficient (“NRC”) as described in ASTM C423, “Standard Test Method for Sound Absorption and Sound Absorption Coefficients by the Reverberation Method.” The NRC value is a scale representation of the amount of sound energy absorbed upon striking a particular surface, with a NRC value of 0 indicating perfect reflection and a NRC of 1.00 representing perfect absorption of sound energy. It is determined from an average of four sound absorption coefficients of the particular surface at frequencies of 250 Hz, 500 Hz, 1000 Hz and 2000 Hz, which cover the range of typical human speech. An acoustical panel with an NRC value of 0.80 absorbs 80% of the sound that strikes it and deflects 20% of the sound. Under some circumstances NRC values greater than 1.00 may be obtained, but this is an artifact of the test method due to diffraction/edge to area effects. In laboratory test of materials in a laboratory per ASTM C423, only the face of the sample is exposed to the sound energy, as would be the case in a typical installation.

The Ceiling Attenuation Class (“CAC”) rating quantifies how much sound is lost when it is transmitted through the ceiling of one room into an adjacent room through a common plenum. A higher CAC rating indicates that the ceiling system allows less sound transmission. The CAC rating is measured using the test standard ASTM E 1414-21, in which the sound levels are measured in the source room and an adjacent room.

The Estimated NRC (ENRC) rating predicts NRC and is conducted following ASTM E1050—Standard Test Method for Impedance and Absorption of Acoustical Materials Using a Tube, Two Microphones and a Digital Frequency Analysis System. This test method uses an impedance tube, two microphones, and a digital frequency analysis system. Testing samples of 100 mm diameter round disks are used, and average absorptions at 250 Hz, 500 Hz, 1000 Hz, and 1600 Hz are used to calculate ENRC values. Empirical correlation can be established so that ENRC provides a very accurate prediction of NRC.

Thus, the term “high acoustic” refers to the basemats or fibrous panels according to the disclosure having an NRC value of at least about 0.80 in combination with a CAC value of at least about 30. In embodiments, the high acoustic basemats or fibrous panels of the disclosure can have an NRC value of about 0.80 to about 1.00, about 0.80 to about 0.95, about 0.85 to about 0.95, or about 0.90 to about 0.95 in combination with a CAC rating of at least about 30, about 35, about 40, about 45, about 50, between about 30 and about 50, between about 35 and about 50, or between about 35 and about 45.

### Basemats

The basemats of the disclosure include a mineral wool, a glass wool, or a combination of a mineral wool and a glass wool, and a binder. The basemats have a backing side and a facing side.

Mineral wool is comprised of fibers of inorganic raw materials. Mineral wool is a term broadly applied to various related vitreous products. In general, mineral wool is a fiberglass-like material composed of very fine, interlaced mineral fibers, somewhat similar in appearance to loose wool. It is composed primarily of silicates of calcium and aluminum, chromium, titanium, and zirconium. Typically, mineral wool is produced from natural rock or slag. Slag is a term broadly applied to refer to waste products of the primary metal and foundry industries, including deposits from a furnace lining charge impurities, ash from fuel, and fluxes used to clean the furnace and remove impurities. Generally speaking, mineral fibers have an appearance that is similar to that of glass fibers, but the chemical composition of mineral wool is significantly different than that of glass fibers due to the high content of iron, calcium, and magnesium and a relatively low proportion of silicon dioxide and aluminum. The mineral wool may be of any of the conventional mineral fibers prepared from basalt, slag, granite, or other vitreous mineral constituent.

Glass wool is typically manufactured using recycled glass. Typically, a combination of recycled glass, soda ash, limestone, and sand is heated to its melting point and then spun into long, ultra-fine glass fiber strands.

In terms of producing wool, known techniques for producing mineral fibers may be used. Representative techniques for producing mineral fibers are described in U.S. Pat. Nos. 2,020,403, 4,720,295, and 5,709,728, each of which is hereby incorporated herein by reference. Mineral wool production involves melting the raw materials, such as slag, basalt, and/or granite, with coke and in the presence of oxygen in a suitable furnace, such as a cupola, and heating the composition to a temperature in the range of 1,400° C. to 2,000° C. Other furnaces, such as an electric furnace or a submerged combustion melting furnace are also suitable. The melt is then spun into wool in a fiberizing spinner via a continuous air stream. During the spinning process, as the molten inorganic material is discharged from a rotor, small globules develop on the rotors and form long, fibrous tails as they travel tangentially. The fibers are then optionally dried, collected, and subjected to further processing. The diameter of the fibers can be controlled by adjusting known variables including spinning wheel speed, the melt temperature, the amount of coke used, selection of raw materials as is well known.

A Diamscope (Fibremetrics Pty Ltd, AU) can be used to measure wool diameters. Fibers are cut using a guillotine device to a length of about 700 microns for fiber dispersion and analysis. The fibers are dropped into a water bowl with a magnetic stirrer to disperse the fibers. The fibers progress through a gap between a right angled prism and a glass window, where images are captured by a digital camera. The fiber images are analyzed for fiber diameter and distribution. Up to 20,000 fibers are counted per minute, which gives reliable diameter distribution, making it possible to monitor fiber diameter accurately and efficiently.

Expressed in terms of percent by weight of the total dry solids content of the final basemat product, the mineral wool, the glass wool, or the combination of mineral wool and glass wool may be present in an amount of at least about 90 wt. %. Thus, herein, the amounts of the various components in the basemat are provided on a dry weight basis of the final basemat (e.g., following dewetting and drying), unless specifically reported otherwise. The mineral wool, the glass wool, or the combination of mineral wool and glass wool can be provided in an amount of at least about 90 wt. %, at least about 91 wt. %, at least about 92 wt. %, at least about 93 wt. %, or at least about 94 wt. % and/or up to about 95 wt. %, based on the total weight of the basemat. The mineral wool, the glass wool, or the combination of mineral wool and glass wool may be provided in an amount of about 90 wt. % to about 95 wt. %, based on the total weight of the basemat.

The fibers of the mineral wool, the glass wool, or the combination of a mineral wool and a glass wool have a mean diameter of at least about 5 microns, at least about 5.5 microns, at least about 6.0 microns, or at least about 6.5 microns. The mineral wool, the glass wool, or the combination of a mineral wool and a glass wool also have a mean diameter of less than about 10 microns, or less than about 9.5 microns. While mineral wool, glass wool, or a combination of a mineral wool and a glass wool always has a size distribution, basemats and fibrous panels typically include wools having diameters of about 4.5 microns or less. Controlling the wool to have a mean diameter greater than about 5 microns, greater than about 5.5 microns, greater than about 6.0 microns, or greater than about 6.5 microns and either less than about 10 microns, or less than about 9.5 microns has been found to be significant for achieving low density basemats and fibrous panels, as well as the bulking and acoustic performance of the basemats and fibrous panels. Different fractions of mineral wool and/or glass wool having different compositions and/or different size distributions can be combined, provided that the fibers of the resulting mixture have a mean diameter of at least about 5 microns, at least about 5.5 microns, at least about 6.0 microns, or at least about 6.5 microns and either less than about 10 microns, or less than about 9.5 microns.

The basemats of the disclosure include a binder. Examples of suitable binders include, but are not limited to, starches, latex, reconstituted paper products, and combinations thereof. In embodiments, the binder is chosen from one or more binders in the group of a starch, a latex, and a reconstituted paper product. In embodiments, the binder includes a starch and a latex. The binder can be present in a total amount of about 1 wt. % to about 10 wt. %, based on the total weight of the basemat. For example, the binder can be present in a total amount of at least about 1 wt. %, at least about 2 wt. %, at least about 4 wt. %, at least about 5 wt. %, or at least about 7 wt. %, up to about 5 wt. %, up to about 7 wt. %, up to about 8 wt. %, or up to about 10 wt. %, based on the total weight of the basemat. Additionally, the binder may be provided in an amount of about 2 wt. % to about 10 wt. %, about 4 wt. % to about 10 wt. %, about 5 wt. % to about 10 wt. %, about 2 wt. % to about 8 wt. %, about 4 wt. % to about 8 wt. %, or about 5 wt. % to about 8 wt. % based on the total weight of the basemat.

The basemats may optionally further include a mineral filler. The terms “mineral filler” and “filler” should be considered interchangeable. As understood by one of ordinary skill in the art, mineral wool, glass wool, or the combination of mineral wool and glass wool are distinct from mineral fillers. Suitable examples of mineral fillers include, but are not limited to, clay, perlite, vermiculite, and combinations thereof. In embodiments, the mineral filler includes perlite, such as expanded perlite. Generally, the mineral filler may optionally be present in an amount of up to about 5 wt. %, for example, in an amount between about 1 wt. % and about 3 wt. %, based on the total weight of the basemat. In embodiments, as described above, the basemat is substantially free of clay, calcium carbonate, magnesium carbonate, vermiculite, glass beads, and/or perlite.

The binder could include starch, latex, and/or a combination of starch and latex. Suitable starch includes native or modified corn starch, wheat starch, tapioca starch, or a combination of the above. Native corn starch is preferred due to abundance and low cost. Example of starch includes pearl corn starch (Tate & Lyle PLC, IL) and corn starch Clinton 106 (Archer Daniels Midland, IL). Starch can be used in a partially gelatinized or non-gelatinized form. Suitable latex include homopolymers, copolymers, and mixtures of polyvinyl acetate, polyvinyl alcohol, polyacrylate, polystyrene-butadiene, or other similar binders. Typically, the starch is a native corn starch, when included. Typically, the latex is a polystyrene acrylic acid/acrylate or a polystyrene butadiene. In one preferred aspect, the latex is a carboxylated styrene butadiene latex or a carboxylated styrene acrylic latex. Suitable binders thus include but are not limited to styrene butadiene latexes, modified styrene butadiene latexes, styrene acrylic latexes, and modified styrene acrylic latexes and include those available under the RHOPLEX™ and UCAR™ tradenames (The Dow Chemical Company, MI), under the ENVERSA™, LOMAX™, and LIGOS™ tradenames (Trinseo, PA), as well as under the ACRONAL® and ACRONAL® MB, BUTOFAN®, and BUTONAL® tradenames (BASF, Germany).

A flocculant/retention aid is typically used during basemat formation to help retain suspended solids present in the aqueous slurry in the final, dried basemat. A wide range of flocculant-retention aids may be used. Flocculant/retention aids can be cationic polymers including but not limited to quaternary ammonium polymers, cationic polyacrylamides, or anionic polymers including but not limited to polyacrylic acids/polyacrylate polymers and copolymers, acrylamide/acrylate copolymers, etc. Other suitable flocculant/retention aids include neutral, nonionic acrylamide polymers as well as amphoteric polymers. Examples of flocculant/retention aids found to be effective include but are not limited to those available under the Bufloc® tradename including but not limited to Bufloc® 5425, Bufloc® 5774, Bufloc® 5932, and Bufloc® 5775 (Buckman Laboratories, Inc.), as well as those available under the Nalco™ tradename including but not limited to Nalco™ 61610, Nalco™ 62101, Nalco™ 63660, Nalco™ 63600, Nalco™ 1409, Nalco™ 3482, and Nalco™ 7128.

The basemats of the disclosure may optionally further include a cellulose. Cellulose, or cellulosic fiber, is an example of an organic fiber which can help provide structural integrity to the final basemat. Cellulosic fibers are typically provided as paper fibers using recycled newsprint. Over Issued Newspaper (OIN) and Old Magazine (OMG) may be used in addition to, or as an alternative, to recycled newsprint. When included, the paper fiber typically is present in an amount of about 1 wt. % to about 5 wt. % cellulose, about 1 wt. %, about 1.5 wt. %, about 2 wt. %, about 2.5 wt. %, or from about 1.5 wt. % to about 3.0 wt. %. In embodiments, as described above, the basemat is substantially free of a cellulose.

The basemats of the disclosure may optionally include gypsum to promote increased retention and drainage during the gravity and vacuum draining processes involved in basemat formation. While in embodiments, the basemats may optionally be substantially free of gypsum, gypsum can be present in a total amount of about 0.25 wt. % to about 2 wt. %, about 0.25 wt. % to about 1.75 wt. %, or about 0.25 wt. % to about 1.5 wt. %, based on the total weight of the basemat.

The basemat can have a thickness of about 1.1 inches to about 1.5 inches. For example, the basemat can have a thickness of at least about 1.1, 1.2, or 1.3 inches, and/or a thickness of up to about 1.4 or 1.5 inches. Thus, the basemat can have a thickness of about 1.1 inches to about 1.4 inches, about 1.2 inches to about 1.5 inches, or about 1.3 inches to about 1.5 inches.

### Fibrous Panels

The disclosure also provides fibrous panels including the basemats as described herein. The fibrous panels further include a porous scrim having a first surface and a second surface, wherein the first surface is in contact with a facing side of the basemat (i.e., the first surface is in contact with the visible side of the fibrous panel that is intended to be directed to an interior of a room).

Suitable scrims and methods for making the same are known in the art. A representative scrim composition and procedure for manufacturing the same is described in U.S. Patent Application Publication No. 2005/0181693, which is hereby incorporated herein by reference. In embodiments, the scrim includes a porous non-woven fiberglass or fiberglass blended material. The scrim may be a non-woven, short or medium strand, continuous fiberglass type material that has a multi-directional and random, overlapping fibrous orientation which allows for significant air permeability and flow in all of its directions. The porous scrim can be laminated to the basemat.

The scrim is typically very permeable due to including many relatively large pores both in the surface and throughout as a result of using relatively coarse fibers. The scrim preferably has suitable porosity to allow airflow and acoustic transmission to the basemat. In one refinement, the scrims comprise glass fibres with nominal length of about 6 mm that are bound by a polyvinyl alcohol binder. Typically, the scrims have a basis weight of about 120 to about 145 g/m2.

In embodiments, the fibrous panel further includes a decorative coating on the second surface of the porous scrim (which is intended to be directed to an interior of a room). The decorative coating may itself include one, two, or more individually applied coating layers. The decorative coating layer(s) can be deposited on the second surface of the porous scrim by curtain coating, spray coating, and/or roller coating. Curtain coating, as is known, is a process in which a curtain coater creates an uninterrupted, free falling vertical curtain flow of a liquid coating composition from a coating chamber and the liquid coating composition is deposited onto a moving substrate. The substrate is moved on a conveyor through the curtain coater at various speeds. In embodiments, the substrate is a fibrous panel, preferably, a ceiling tile. Spray coating, as is known, is frequently used to apply coatings onto various substrates. A conventional spray coating process comprises pumping a coating composition through filters into a spray head. In embodiments, the spray head may reciprocate perpendicular to the direction of the movement of a substrate as is known in the art. In spray coating, a coating is created from the spray head in the form of droplets and coats the substrate. Roller coating, as is also known, can also be used to apply a coating onto the second surface of the porous scrim by using a roller to distribute the coating composition over the substrate.

Typically, two decorative front coatings are applied on the second surface of the porous scrim (corresponding to the facing side of the basemat) by reciprocating spray coaters using a spray nozzle to ensure even application of the coating. In alternative embodiments, the decorative coating(s) applied on the second surface of the porous scrim include a first coating deposited by curtain coating and a second coating deposited thereover by spray coating. Coat weight is a measurement of the amount of coating added to the fibrous panel substrate. The coat weight can be controlled as is known in the art. Typically, the applied decorative coating(s) has a dry coating weight in a range from about 7.5 g/ft² to about 25 g/ft². In one refinement, the fiberglass scrim with decorative front coating(s) has a combined airflow resistance of about 200 l/m²·s to about 400 l/m²·s at 100 Pa.

The fibrous panel also typically comprises a back coating on a backing surface of the basemat. The back coating may itself include one, two, or more individually applied coating layers. The back coating may enhance acoustical performance, particularly CAC rating, by attenuating any sound transmitted through the panel to the plenum space adjacent to the fibrous panel. On the other hand, the back coating may cause sound to be reflected and effectively retransmitted through the fibrous panel back into the site of sound origin, especially when the dry coating weight of the back coating exceeds 25 g/ft². Advantageously, when a basemat comprising at least about 90 weight percent mineral wool, based on the weight of the (dried) basemat, is provided as a single layer having a thickness of greater than about 1.1 inches (2.80 cm), excellent CAC ratings may be achieved without significantly decreasing NRC ratings. As a result, both a high NRC and a high CAC can be achieved at the same time. Typically, two back coatings are applied on the backing side of the basemat by roller coating. Generally, the back coating has a dry coating weight in a range from about 15 g/ft² to about 45 g/ft², about 20 g/ft² to about 45 g/ft², about 25 g/ft² to about 45 g/ft², or from about 30 g/ft² to about 45 g/ft². The overall structure of fibrous panels with front and back coatings is well known, for example, as illustrated and described in US 2018/0079691, which is incorporated herein by reference in its entirety.

In embodiments, the liquid coating compositions for the decorative and the back coatings are provided an aqueous-based coating composition, comprising water, binder(s), filler(s), and additive(s). In embodiments, the binders are latex polymers. In embodiments, suitable fillers include, but are not limited to, calcium carbonate, titanium dioxide, clay, and the like. In embodiments, the additives can include, but are not limited to, dispersants, water softeners, surfactants (e.g., non-ionic surfactants), biocides, defoamers, thixotropic agents, flow agents, and combinations thereof. In some embodiments, a liquid coating composition for application as either the decorative coating or the back coating comprises about 30 wt. % to about 65 wt. % of water, about 0 wt. % to about 10 wt. % of binder, specifically, a latex polymer binder, about 30 wt. % to about 65 wt. % of filler, and about 0.01 wt. % to about 10 wt. % of additives. Total solids for the coating compositions typically exceed about 50 wt. % and are generally present in an amount between about 50 wt. % and about 60 wt. %. Coating composition components are described by a mass of solids where applicable (thus, in the aforementioned liquid coating composition, the latex polymer component is expressed as solids only, and any water that may be present is included with the water component). In a preferred embodiment, when two coatings are applied to provide the back coating on the fibrous substrate, in order to further enhance the CAC rating, the coating composition used to provide the second coating layer in the back coating process includes a greater amount of latex polymer binder than is present in the coating composition used to provide the first coating layer in the back coating process, on a relative weight percent basis. For example, the first back coating can comprise water, a filler such as clay, and less than 1 wt. % (solids) of various additives (˜54 wt. % total solids), and the second back coating can comprise water, clay, latex, and less than 1 wt. % (solids) various additives (˜55.5 wt. % total solids).

### Dewatering

Acoustical panels can be prepared using the basemat composition of the disclosure according to, for example, a wet felted production process. One version of this process is described in U.S. Pat. No. 5,911,818, herein incorporated by reference in its entirety. In general, an aqueous slurry including a dilute aqueous dispersion of the basemat composition is delivered onto a moving foraminous wire of a Fourdrinier-type mat forming machine. The basemat slurry is initially dewatered by gravity and is further dewatered by means of vacuum suction. A pressing step may also be carried out to achieve a desired thickness. The dewatered basemat can then be dried in a heated oven or kiln to remove residual moisture and form dried basemats. Panels of acceptable size, appearance and acoustic properties are obtained by finishing the dried basemat. Finishing includes surface grinding, cutting, perforation and/or fissuring, roll coating, spray coating, edge cutting and/or laminating the panel onto a scrim or screen.

To provide lab-scale samples, the aqueous slurry of the dilute aqueous dispersion of the basemat composition can be provided to a Tappi former. The slurry is dewatered by gravity followed by vacuum suction. A pressing step may also be carried out to achieve a desired thickness. The dewatered basemat may then be dried in a heated oven or kiln, e.g., by convection drying or through drying, to provide a dried lab-scale basemat. Panels of acceptable size, appearance and acoustic properties are obtained by finishing the dried basemat as described above.

In embodiments, the application of a vacuum to the wet basemat comprises a first vacuum step and a second vacuum step. Typically, a pressing step may be provided between the first vacuum step and second vacuum step. The wet basemat may be pressed to achieve a desired thickness. Suitably, the thickness of the wet basemat after pressing may be in a range of about 1.1 inches to about 2.0 inches or about 1.15 inches to about 1.55 inches.

A vacuum of about 3 inches of mercury (inHg) to about 15 inHg may be applied during dewatering. In embodiments, a first vacuum of about 3 inHg (about 0.10 bar) to about 7 inHg (about 0.23 bar), or about 4 inHg (about 0.13 bar) to about 6 inHg (about 0.20 bar), for example, about 3 inHg, about 4 inHg, about 5 inHg, about 6 inHg, or about 7 inHg may be applied followed by a second, higher vacuum of about 5 inHg (about 0.17 bar) to about 15 inHg (about 0.51 bar), about 6 inHg to about 14 inHg (about 0.47 bar), about 7 inHg to about 13 inHg (about 0.44 bar), about 8 inHg (about 0.27 bar) to about 12 inHg (about 0.41 bar), or about 9 inHg (about 0.30 bar) to about 11 inHg (about 0.37 bar), for example, about 5 inHg, about 6 inHg, about 7 inHg, about 8 inHg, about 9 inHg, about 10 inHg, about 11 inHg, about 12 inHg, about 13 inHg, about 14 inHg, or about 15 inHg.

### Drying

The methods of the disclosure typically further comprise an additional drying step. The dewatered basemat may be further dried in a heated oven or kiln. As the dewatered basemats may take hours to dry in the oven or kiln, the amount of basemats produced is limited by how many basemats can be dried. Accordingly, the more water that can be removed during the dewatering step, the less time the basemats will need in the oven to dry, the less costly the basemats will be to produce, and the number of basemats produced can advantageously be increased.

In a preferred embodiment, the drying step is carried out, at least in part, by “through drying” which as used herein includes pulling hot air through the dewatered basemat via vacuum, when the dewatered basemat is in an oven or kiln. Suitable apparatus and methods for conducting through drying are disclosed in U.S. Pat. No. 5,047,120, which is hereby incorporated by reference in its entirety. The dewatered basemats may be dried at any suitable temperature, as long as the surfaces of the basemat do not darken or burn. In embodiments, the dewatered basemats may be dried at a temperature of about 300° F. (about 150° C.) to about 600° F. (about 315° C.), about 400° F. (about 205° C.) to about 600° F., or about 450° F. (about 230° C.) to about 550° F. (about 290° C.), for example, about 250° F., about 300° F., about 400° F., about 450° F., about 500° F., about 550° F., or about 600° F. A vacuum of about 1.50 inches of mercury (inHg) to about 15 inHg is typically applied while drying the basemats in the oven/kiln. Different drying temperatures and vacuum pressure differentials may be used at different location/zones of the oven/kiln.

### EXAMPLES

### Example 1—Preparation and Evaluation of Basemats

Basemats according to the invention were prepared using the formulations provided in Table 1.

TABLE 1
Basemat Composition (solids)

| Component | Basemat 1 | Basemat 2 |
|---|---|---|
| Mineral wool with mean diameter | 91.5 | 91.5 |
| greater than 5 microns (wt. %) | | |
| Latex binder | 6.5 | 6.5 |
| (carboxylated polystyrene acrylate polymer) | | |
| Filler (gypsum) | 1.5 | 1.5 |
| Flocculation/retention aid | ~0.5 | ~0.5 |
| (cationic polyacrylamide polymer) | | |

The basemat 1 ingredients were mixed with water to provide a mixture at about 4.2% consistency/solids, drained with gravity followed by vacuum, then pressed to desired thickness of about 1.45 inches. After through drying, the basemat was ground to about 1.3 inch thickness with density of 8-9 lbs/ft³. The resultant basemat has an ENRC (estimated NRC) of >0.95.

The basemat 2 ingredients were mixed with water to provide a mixture at about 4% consistency/solids, drained with gravity followed by vacuum, then pressed to desired thickness of about 1.45 inches. After through drying, the basemat was ground to about 1.3 inch thickness with density of 9-10 lbs/ft³. The resultant basemat has an ENRC (estimated NRC) of >0.95.

In basemat 1, two fractions of mineral wool were combined to provide mineral wool having a mean diameter of about 6 microns, specifically, about 33.3% of a first fraction having a mean diameter of about 4 microns and 66.7% of a second fraction having a mean diameter of about 8 microns.

In basemat 2, two fractions of mineral wool were combined to provide mineral wool having a mean diameter of about 5.8 microns, specifically, about 33.3% of a first fraction having a mean diameter of about 4.5 microns and 66.7% of a second fraction having a mean diameter of about 7.0 microns.

Example 1 demonstrates basemats comprising more than 90 wt. % mineral wool, glass wool, or a combination of mineral wool and glass wool, based on the weight of the basemat, having a mean diameter of greater than about 5.0 microns, according to the disclosure, demonstrate excellent acoustic performance while being provided as a single-layer having a thickness of greater than 1.1 inches.

### Example 2—Evaluation of Ceiling Tiles

To evaluate finished production ceiling tile products, aqueous slurries comprising the listed ingredients at about 4-4.5% consistency/solids were drained with gravity, followed by vacuum, pressed to desired thickness, then dried using through drying process (without any further drying operation), and ground to caliper, thereby forming basemats, which were then laminated with a non-woven fiberglass scrim. Two layers of coating composition were applied to provide a front (decorative) coating over the scrim via spray coating, and two layers of coating composition were applied to provide a back coating on the backing surface of the basemat via roller coating. The acoustical performance of the ceiling tiles, other parameters, as well as the formulations used to make the ceiling tiles are shown in Table 2.

TABLE 2
Ceiling Tiles

| Component | Tile 1 | Tile 2 | Tile 3 | Tile 4 | Tile 5 | Tile 6 | Tile 7 |
|---|---|---|---|---|---|---|---|
| Mineral wool | 91.5% | 91.3% | 91.1% | 91.4% | 91.4% | 91.5% | 90.5% |
| (wt. %) with | | | | | | | |
| mean diameter | | | | | | | |
| greater than 5 | | | | | | | |
| microns (wt. %) | | | | | | | |
| Starch (wt. %) | 4.1% | 4.1% | 4.1% | 2.9% | 4.1% | 4.1% | 4.3% |
| (native corn | | | | | | | |
| starch) | | | | | | | |
| Latex (wt. %) | 3.0% | 3.0% | 3.0% | 4.3% | 3.1% | 3.1% | 3.5% |
| (carboxylated | | | | | | | |
| polystyrene | | | | | | | |
| acrylate polymer) | | | | | | | |
| Filler (gypsum) | 1.4% | 1.6% | 1.8% | 1.4% | 1.4% | 1.3% | 1.7% |
| Flocculation/ | <0.1% | <0.1% | <0.1% | <0.1% | <0.1% | <0.1% | <0.1% |
| retention aid | | | | | | | |
| (wt. %) (cationic | | | | | | | |
| polyacrylamide | | | | | | | |
| polymer)) | | | | | | | |
| Total Back | 63 g/sf², | 55 g/sf², | 61 g/sf², | 61 g/sf² | 37 g/sf² | 36 g/sf² | 35 g/sf² |
| Coating | (39 g/sf², | (35 g/sf², | wet (35 g/sf², | (39 g/sf², | (21 g/sf², | (20 g/sf², | (21.5 g/sf², |
| (wet g/f²) | 54% solids, | 54% solids, | 54% solids, | 54% solids, | 54% solids, | 54% solids, | 54% solids, |
| | 1^{st} coat, and | 1^{st} coat, | 1^{st} coat, | 1^{st} coat, | 1^{st} coat, | 1^{st} coat, | 1^{st} coat, |
| | 24 g/sf², | 20 g/sf², | 26 g/sf², | 22 g/sf², | 16 g/sf², | 16 g/sf², | 13.5 g/sf², |
| | 55.5% solids, | 55.5% solids, | 55.5% solids, | 55.5% solids, | 55.5% solids, | 55.5% solids, | 55.5% solids, |
| | 2^{nd} coat) | 2^{nd} coat) | 2^{nd} coat) | 2^{nd} coat) | 2^{nd} coat) | 2^{nd} coat) | 2^{nd} coat) |
| Thickness | ~1.3 | 1.32 | 1.30 | 1.28 | 1.32 | 1.32 | 1.21 |
| (inches) | | | | | | | |
| Density (lbs/ft³) | 13.7 | 12.2 | 13.2 | 13.8 | 11.9 | 11.2 | 13.4 |
| Weight (lbs/sf) | 1.48 | 1.34 | 1.43 | 1.47 | 1.31 | 1.23 | 1.35 |
| NRC | 0.90 | 0.95 | 0.90 | 0.90 | 0.95 | 1.00 | 0.95 |
| CAC | 42 | 35 | 40 | 42 | 35 | 30 | 33 |

In tiles 1, 3, and 4, the mineral wool had a mean diameter of about 5.2 microns. In tiles 2, 5, and 7, two fractions of mineral wool were combined to provide the mineral wool having a mean diameter of about 5.5 microns, specifically, about 33.3% of a first fraction having a mean diameter of about 4-5 microns and 66.7% of a second fraction having a mean diameter of about 7-8 microns. In tile 6, the mineral wool had a mean diameter of about 7-8 microns.

Example 2 demonstrates relatively high-caliper fibrous panels comprising single-layer basemats comprising more than 90 wt. % mineral wool, glass wool, or a combination of mineral wool and glass wool, based on the weight of the basemat, according to the disclosure, demonstrate excellent NRC and CAC ratings at the same time, which is particularly surprising especially when the ceiling tiles include a back coating having a dry coating weight of greater than 25 g/f², or even greater than 30 g/f² or greater (as shown in Ceiling Tiles 1, 2, 3, and 4).

### Example 3—Effect of Through Drying Process

To evaluate the effect of the through drying process, the same basemat composition was used to prepare a basemat according to the disclosure using through drying and compared to a basemat according to the disclosure using conventional drying. The basemat composition included 92% mineral wool, 7% latex (carboxylated polystyrene acrylate polymer), and 1% flocculation/retention aid (cationic polyacrylamide polymer). The ingredients were mixed with water to provide a mixture at about 4% consistency/solids, drained with gravity followed by vacuum, then pressed to desired thickness of about 1.10 inches. When dried using convection drying at about 300° F. to about 350° F., the basemat took about two to three hours to dry and yielded a basemat with a ENRC of 0.89 at a thickness of about 1.04 inches after grinding. When dried using through drying at about 300° F. to about 400° F., the basemat took about two minutes to dry and yielded a basemat with a ENRC of 0.92 at a thickness of about 1.05 inches after grinding.

Example 3 therefore demonstrates both a surprising increase in acoustic performance when through drying is used, as well as an advantageous reduction in drying time and energy requirements for manufacturing basemats according to the disclosure. It is believed that through drying basemats comprising at least about 90 wt. % mineral wool, glass wool, or a combination of mineral wool and glass wool, based on the weight of the (dried) basemat, microns increases the number of porous-type channels in the basemat and thereby enhances acoustic performance, which is reflected in the surprisingly increased ENRC rating.

The foregoing description is given for clearness of understanding only, and no unnecessary limitations should be understood therefrom, as modifications within the scope of the invention may be apparent to those having ordinary skill in the art.

All patents, publications and references cited herein are hereby fully incorporated by reference. In case of a conflict between the present disclosure and incorporated patents, publications, and references, the present disclosure should control.

1. A process for manufacturing an acoustical panel comprising:
mixing an aqueous slurry comprising water and ingredients on a dry basis, by weight percent (wt. %):
at least about 90 wt. % of mineral wool, glass wool, or a combination of mineral wool and glass wool, the mineral wool, the glass wool, or the combination of mineral wool and glass wool having an average diameter of at least about 5 microns, and
about 1 wt. % to about 10 wt. % of a binder;
continuously flowing the aqueous slurry onto a moving foraminous support wire to form a wet basemat;
dewatering the wet basemat, the dewatering step including pressing the wet basemat to a thickness of about 1.1 inches to about 2.0 inches; and
pulling hot air through the wet basemat via vacuum through drying to form a dried basemat;
laminating a porous scrim to a facing side of the dried basemat;
wherein the acoustical panel has a density between about 7 pounds per cubic foot (lbs/ft³) to about 12 lbs/ft³, wherein the acoustical panel has a thickness of greater than about 1.1 inches,
wherein the acoustical panel has a noise reduction coefficient (NRC) of about 0.80 to about 1.00, and
wherein the acoustical panel has a ceiling attenuation class (CAC) of about 30 to about 50.

2. The process for manufacturing an acoustical panel of claim 1, further comprising applying a decorative coating to a facing side of the basemat.

3. The process for manufacturing an acoustical panel of claim 1, wherein the decorative coating has a dry coating weight in a range from about 7.5 g/ft² to about 25 g/ft².

4. The process for manufacturing an acoustical panel of claim 1, further comprising applying a back coating on a backing side of the basemat in a dry coating weight range from about 15 g/ft² to about 45 g/ft².

5. The process for manufacturing an acoustical panel of claim 1, wherein the hot air during vacuum drying has an initial temperature in a range of about 250° F. (about 120° C.) to about 600° F. (about 316° C.).

6. The process for manufacturing an acoustical panel of claim 1, wherein a vacuum of about 1.5 inches of mercury (inHg) to about 15 inHg is applied during vacuum drying.

7. The process for manufacturing an acoustical panel of claim 1, wherein the basemat is substantially free of glass beads and perlite.

8. The process for manufacturing an acoustical panel of claim 1, wherein the binder comprises one or more binders chosen from the group of starches and latexes.

9. The process for manufacturing an acoustical panel of claim 1, wherein the mineral wool, the glass wool, or the combination of mineral wool and glass wool have an average diameter of at least about 5.5 microns, and less than about 10 microns.

10. The process for manufacturing an acoustical panel of claim 1, the basemat further comprising a flocculation/retention aid.

11. The process for manufacturing an acoustical panel of claim 1, wherein the basemat thickness is less than 1.4 inches (3.56 cm).

12. The process for manufacturing an acoustical panel of claim 1, wherein the basemat is substantially free of clay, substantially free of gypsum, substantially free of calcium carbonate, substantially free of magnesium carbonate, and/or substantially free of vermiculite.
